(19) United States
(12) Patent Application Publication
(10) Pub. No.: US 2007/0034561 A1
(43) Pub. Date: Feb. 15, 2007

(54) Water Deionization Manifold

(76) Inventor: Vincent P. Kearl, Salt Lake City, UT (US)

Correspondence Address: GEOFFREY E. DOBBIN, PATENT ATTORNEY, 4278 SOUTH 6220 WEST, WEST VALLEY CITY, UT, 84128-6501, US

(21) Appl. No.: 11/161,638

(22) Filed: Aug. 10, 2005

(51) Int. Cl. C02F 1/42

(52) U.S. Cl. 210/287

(57) ABSTRACT

The present invention is a manifold for insertion within a pressure washing system to create deionized water on demand for spot-free rinsing. The manifold comprises necessary conduit and a pumping apparatus to divert water through an associated deionization system.

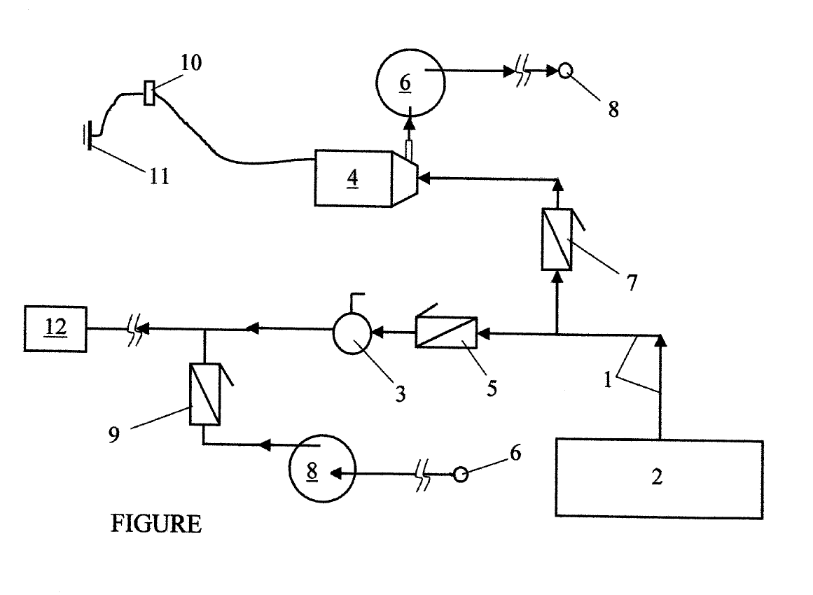

### FIELD OF THE INVENTION

The field of the present invention is fluid-handling manifolds and more particularly relates to a fluid-handling manifold that is capable of diverting water through a deionization system for on-demand production.

### BACKGROUND OF THE INVENTION

The use of deionized water is well known in washing arts. Deionized water is used in rinsing processes to produce a “spot-free” shine after the water dries, eliminating labor previously used to dry a surface before the water dried and spotted. The theory is simple. Water contains both positive and negative ion impurities from dissolved solids like sodium chloride (NaCl). These impurities are left after water evaporates and form a spot. Deionization processes remove these impurities by filtering the water through both a cation and an anion resin, which replace positive (Na⁺) and negative (Cl⁻) ion impurities with H⁺ and OH⁻ ions respectively. The H⁺ and OH⁻ ions then combine to form pure H₂O, deionized water. The resins are usually separated into two beds, and the water run sequentially through said beds, so as to make recharging the filtering resins easier. Water deionization is a more efficient process in a mixed bed, but the prevalence of separate beds, at this time, makes it the primary deionization system discussed in this application.

In the mobile pressure-washing field, a cleaning agent is sprayed unto the object to be cleaned through a pressurized system. After cleaning is accomplished, a rinse is accomplished in a similar manner. Usual designs in the prior art allow for either some type of reservoir switch, between a cleaning and a rinsing reservoir, to be accomplished or for the cleaning agent to be alternatively added or withheld from a water stream from one reservoir. In the former situation, two reservoirs must be carried to the work site, increasing cost and labor. The rinse reservoir may be deionized water, but must be filled with such before a job. In the later situation, either the entire reservoir is deionized water, which is more expensive, or not, which eliminates the possibility of spot-free, air-drying. The present invention departs from the prior art by providing a manifold that allows for on-demand, on-site production of deionized water for a spot-free rinse from a single storage tank of regular tap water that is likewise used for regular washing purposes.

### SUMMARY OF THE INVENTION

In view of the foregoing disadvantages inherent in the known types of pressure washing systems, this invention provides an improved water diversion manifold. As such, the present invention's general purpose is to provide a new and improved manifold that will provide water deionization on demand for a pressure washing system.

The present invention is a supply manifold for carrying water from a holding tank to a pressure water. The manifold may allow regular tap water to supply the pressure washing apparatus or may divert water through a deionization system to provide deionized water to the pressure water. To accomplish these goals, the manifold comprises necessary conduit to transport water from a holding tank to a pressure washing system and a diversionary system, further comprising further conduit and a pumping apparatus. Check valves are employed to prevent backflow of water and to maintain priming of the pump. The pump is required to supply large quantities of deionized water to the pressure washing system. In order for such quantities, which should maintain a minimum of 5 gallons per minute, an auxiliary pump is necessary to force water through the deionization system. Using the pump also allows for instant diversion of water into the deionization system at the activation of the pump switch, rather than relying on siphoning and the closing of valves.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The FIGURE is a schematic diagram of the manifold according to the present invention.

### DETAILED DESCRIPTION OF THE PREFERRED EMBODIMENT

With reference now to the drawing, the preferred embodiment of the manifold is herein described. It should be noted that the articles “a”, “an” and “the”, as used in this specification, include plural referents unless the content clearly dictates otherwise.

The manifold system delivers water, held in holding tank 2, through conduit system 1, to pressure washing system 12. The manifold diverts water on one of two paths. The first path, defined by the presence of ball valve 3, is a direct line from tank 2 to pressure washing system 12. Water diverted though this path is plain tap water, used in washing. The second path is the deionization path, defined by cation filter 6 and anion filter 8. Pump 4 is activated to provide suction and divert water into the second path. Check valve 7 is installed before pump 4 in the path so as to keep pump 4 primed. Pump 4 forces water into cation filter 6, which removes positive ions from the water, and anion filter 8, removing negative ions. The filters 6, 8 replace ions with H⁺ and OH⁻ ions respectively, which then fuse into pure, deionized H₂O. From anion filter 8, water is directed back into the first path and into the pressure washing system to provide a spot-free rinse. Check valves 5 and 9 are supplied to prevent backwash of deionized water into the tank or fresh water into the deionization system, respectively.

For the preferred embodiment, which is for a portable commercial system suitable for installation in a trailer, check valves 5 and 7 should be ½-inch swing check valves while check valve 9 should be a ½-inch spring check valve. It should be noted, however, that any type of check valve might be used and adapted for these purposes in the manifold. Ball valve 3 is likewise ½-inch and is provided as a safety valve. It may be left open throughout operation though it is preferred to close it after pump activation. The closed ball valve 3 prevents fresh water from mixing with deionized water in the event of a power failure to the pump and also allows notice of the situation when water pressure is decreased. Without closing the valve 3, the pump in the pressure washing system 12 would pull fresh water through the manifold if pump 4 failed in any manner and there could be no discernable difference between the fresh water and deionized water pressure. As such, a power failure, without closing ball valve 3, could be undetected until after a job had been completed. Ball valve 3 may also be closed for to force diversion of water into the deionization system, though the siphon created by the pump in pressure washing system 12 is generally insufficient for proper operation of an on-demand deionization system. Pump 4 should provide at least ½ HP and should be attached to a power source 11 with a GFI protected power supply cord 10. Ideally, the power supply should be a US standard 110 Volt AC source, though alternate AC power sources or a DC power source and compatible pump may also be used. Larger and smaller systems are easily conceived by altering the sizes and capacities of the manifold and system components to correspond with demand. As such, size limitations recited for the preferred embodiment should be in no manner limiting to the claims that follow.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A fluid diversion manifold comprising:
A fluid carrying conduit network further comprising:
A primary fluid input;
An auxiliary fluid output;
An auxiliary fluid input; and
A primary fluid output, said primary fluid input and primary fluid output maintaining a direct conduit connection with each other capable of bypassing the auxiliary fluid input and auxiliary fluid output in that the auxiliary fluid output and auxiliary fluid input branch away from the direct conduit connection between the primary fluid input and primary fluid output;
A pumping apparatus positioned to divert fluid through the auxiliary fluid output; and
A primary check valve positioned in the direct conduit connection between the auxiliary fluid output and auxiliary fluid input such that fluid travels through the conduit from the auxiliary output to the auxiliary input.

2. The manifold of claim 1 further comprising a backwash check valve within the auxiliary fluid input, wherein water may not be forced out of the manifold through the auxiliary fluid input.

3. The manifold of claim 2 further comprising a priming check valve within the auxiliary fluid output and before the pumping apparatus, wherein the priming check valve maintains water in the vicinity of the pumping apparatus so as to keep said pumping apparatus primed.

4. The manifold of claim 1 further comprising a priming check valve within the auxiliary fluid output and before the pumping apparatus, wherein the priming check valve maintains water in the vicinity of the pumping apparatus so as to keep said pumping apparatus primed.

5. The manifold of claim 1, further comprising a safety valve located proximate the primary check valve.

6. The manifold of claim 5, the safety valve being a ball valve.

7. The manifold of claim 1, the pumping apparatus being a fluid pump of at least ½ horsepower.

8. The manifold of claim 7, the pump being powered by alternating current.

9. The manifold of claim 7, the pump being powered by direct current.

10. A fluid diversion manifold comprising:
A means to carry fluids further comprising:
A primary fluid input;
An auxiliary fluid output;
An auxiliary fluid input; and
A primary fluid output, said primary fluid input and primary fluid output maintaining a direct fluidic connection with each other capable of bypassing the auxiliary fluid input and auxiliary fluid output in that the auxiliary fluid output and auxiliary fluid input branch away from the direct fluidic connection between the primary fluid input and primary fluid output;
A means to divert fluid through the auxiliary fluid output; and
A means to prevent backflow between the auxiliary fluid output and auxiliary fluid input such that fluid travels through the means to carry fluids from the auxiliary output to the auxiliary input.

11. The manifold of claim 10 further comprising a second means to prevent backflow within the auxiliary fluid input, wherein water may not be forced out of the manifold through the auxiliary fluid input.

12. The manifold of claim 11 further comprising a third means to prevent backflow within the auxiliary fluid output, wherein water may not be forced into the manifold through the auxiliary fluid output.

13. The manifold of claim 10 further comprising a second means to prevent backflow within the auxiliary fluid output, wherein water may not be forced into the manifold through the auxiliary fluid output.

14. The manifold of claim 10, further comprising a safety valve located between the auxiliary fluid output and the auxiliary fluid input in the direct fluidic connection between the primary fluid input and primary fluid output.

15. The manifold of claim 14, the safety valve being a ball valve.

16. The manifold of claim 10, the means to divert fluid being a fluid pump of at least ½ horsepower.

17. The manifold of claim 16, the pump being powered by alternating current.

18. The manifold of claim 16, the pump being powered by direct current.
